(19) United States
(12) Patent Application Publication
(10) Pub. No.: US 2014/0075946 A1
(43) Pub. Date: Mar. 20, 2014

(54) Hydroelectric Power Generation Device

(71) Applicant: Tien-Chuan CHEN, Hsinchu Hsien (TW)

(72) Inventor: Tien-Chuan CHEN, Hsinchu Hsien (TW)

(21) Appl. No.: 13/622,486

(22) Filed: Sep. 19, 2012

(51) Int. Cl. F02B 73/00

(52) U.S. Cl. 60/698

(57) ABSTRACT

A hydroelectric power generation device, comprises at least a potential energy generation unit including a control and load device, a withdrawal tank, a withdrawal pipe and a collection tank, where the control and load device acquires water from the withdrawal tank through the withdrawal pipe, and the collection tank is used to receive the water discharged from the control and load device; a steam boiler, acquiring hot water from a heat storage bucket of a solar water heater by way of a lower pipeline and generating steam, and then discharging steam to the control and load device via an upper pipeline; a gravity transmission unit, receiving water from the collection tank; and a generator set, converting the gravity introduced by the water in the collection tank into rotations thereby further generating electrical power.

### BACKGROUND OF THE INVENTION

1. Field of the Invention

The present invention relates to a hydroelectric power generation device, which applies solar energy, especially through cyclic water withdrawals, and converts into potential energy thereby driving electrical power generators through gravity transmissions for power generations.

2. Description of Related Art

The progress of modern life promotes higher and higher demands on electrical power. At present, common power generation approaches include thermal power generations by means of such as coals, gases or heavy oils, nuclear power generations through nuclear fissions, hydroelectric power generations based on conversions of potential energy from reservoir water level releases, as well as wind power generations, solar power generations and so forth.

Each of these power generation methods has its own drawbacks, however. For example, the thermal power generation may emit massive amount of carbon dioxides, leading to the concern of greenhouse effect. Therefore, in accordance with the agreements on the Kyoto Protocol, the international community endeavors to achieve the goals of energy saving and carbon emission reductions, so the development of thermal power generations is quite restricted. Nuclear power generation technologies indeed provide many advantages such as high power generation performance, but, due to the issue of nuclear wastes as well as catastrophic nuclear events occurred previously in Japan, members in European Union are gradually in favor of nuclear power plant shutdown.

On the other hand, the hydroelectric power generation so far represents a more environmentally protective method for power generation, in a relative sense, and provides better conversion efficiency than wind power generation and solar power generation approaches. Currently, this type of power generation usually requires the construction of a dam or reservoir at the upstream of a river for water interception and water storage, and, during the periods of greater water inflows, discharges water containing higher potential energy from the upstream to downstream thereby driving power generators to rotate for power generation. However, since human demands for electrical power keep increasing, the constructions of dams and reservoirs for power generation inevitably cause more valley tribes to be submerged under water because of water storage, resulting in agonies to mountain inhabitants and calamities for the natural environment, thus leading to extensive rejections to this type of power generation. Moreover, due to climate changes, typhoons or storms may cause the dam or reservoir to be under the threat of landslides or silt sedimentations, all of which may undesirably reduce the performance of hydroelectric power generation. Consequently, a new type of hydroelectric power generation featuring environmental friendliness, simplicity and reduced construction costs is needed.

### SUMMARY OF THE INVENTION

The present invention discloses a hydroelectric power generation device, comprising: at least a potential energy generation unit, each of the potential energy generation units including a control and load device, a withdrawal tank, a withdrawal pipe and a collection tank, in which the control and load device is connected to the withdrawal tank through the withdrawal pipe such that the water in the withdrawal tank can be withdrawn to the control and load device through the withdrawal pipe, and the collection tank is connected to the control and load device so as to receive the water discharged from the control and load device; a steam boiler, including an upper pipeline and a lower pipeline and connected to each of the control and load devices via the upper pipeline, generating steam and discharging the steam to the control and load device through the upper pipeline; a solar water heater, including a heat storage bucket and a hot water output pipe and connecting the heat storage bucket to the lower pipeline of the steam boiler through the hot water output pipe to provide hot water to the steam boiler; a gravity transmission unit, connected to the collection tank of the control and load device and receiving water from the collection tank to further create gravity kinetic energy; and a generator set, connected to the gravity transmission unit and driven to rotate with the gravity kinetic energy created by the gravity transmission unit thereby further generating electrical power.

In a preferred embodiment, in case that the number of the at least a potential energy generation units is more than two, the withdrawal tank and the collection tank in each of potential energy generation units is respectively connected.

In a preferred embodiment, the control and load device includes a pedestal, a heat insulation outer frame, a water level gauge, a microcomputer controller, a multi-leveled control sense component, an electromagnetic valve steam inlet, an electromagnetic valve steam outlet, an electromagnetic valve air inlet and an electromagnetic valve water outlet; in which the multi-leveled control sense component includes an upper water level limit sensor and a lower water level limit sensor which are installed inside the heat insulation outer frame; in which the microcomputer controller is connected to the electromagnetic valve steam inlet, the electromagnetic valve steam outlet, the electromagnetic valve air inlet and the electromagnetic valve water outlet and installed outside the heat insulation outer frame, and also the microcomputer controller is connected to the upper water level limit sensor and the lower water level limit sensor in the multi-leveled control sense component thereby detecting the upper limit and the lower limit of the water level; in which the heat insulation outer frame is connected to the withdrawal pipe, the withdrawal pipe is connected to the withdrawal tank, the electromagnetic valve water outlet is connected to the collection tank, and the microcomputer controls the opening and closing states of the electromagnetic valve steam inlet, the electromagnetic valve steam outlet, the electromagnetic valve air inlet and the electromagnetic valve water outlet so as to enable or disable water withdrawals from the withdrawal tank or otherwise enable or disable water discharges from the control and load device.

In a preferred embodiment, the control and load device enables the electromagnetic valve steam inlet, the electromagnetic valve steam outlet, the electromagnetic valve air inlet and the electromagnetic valve water outlet to withdraw water from the withdrawal tank through the withdrawal pipe, and when the microcomputer controller detects the water level reaches the lower water level limit, at least a steam inlet is opened to inject the steam such that the air in the control and load device is discharged from the at least a steam outlet, and then the at least a steam inlet and the at least a steam outlet are closed such that the inside of the control and load device demonstrates a low-pressure condition thereby automatically sucking in water through the withdrawal pipe, until the microcomputer controller detects the water level rises up to reach the upper water level limit sensor, then the at least an air inlet and a water outlet are opened to discharge the water to the collection tank, thus operating repeatedly.

In a preferred embodiment, the potential energy generation unit further includes a supporter thereby positioning the control and load device, the withdrawal pipe and the withdrawal tank in fixation.

In a preferred embodiment, the gravity transmission unit includes a Π-shaped top board, a bottom board, two upper bearing transmission devices, two lower bearing transmission devices, two chain sprockets and a plurality of load devices, in which the Π-shaped top board is fixed to the bottom board and connected to the collection tank, the bottom board is connected to the withdrawal tank, the two upper bearing transmission devices and the two lower bearing transmission devices are respectively installed in pair on an upper part and a lower part of the Π-shaped top board, the two lower bearing transmission devices are further respectively connected to the generator set, the two chain sprockets are installed in pair on the upper bearing transmission devices and the lower bearing transmission devices, and the plurality of load devices are connected between the two chain sprockets.

In a preferred embodiment, the load devices start to descend upon being filled with water from the collection tank, and the gravity thus introduced drives the two upper bearing transmission devices and the two lower bearing transmission devices to rotate thereby driving the generator set connected to the lower bearing transmission devices to generate electrical power; when the load devices descend to reach the bottom board, the water is drained from the load devices and flows to the withdrawal tank, then the load devices ascend, thus operating repeatedly.

In a preferred embodiment, the solar water heater includes a solar radiation heat, a heat collection board, a heat storage bucket, a cool water input pipe and a hot water output pipe, in which the heat collection board receives solar radiation heat such that the water inside the cool water input pipe is heated as flowing through the heat collection board, then transferred into the heat storage bucket and further to the steam boiler by way of the hot water output pipe.

In a preferred embodiment, the present invention further comprises, by means of a withdrawal inlet, a withdrawal channel and a discharge channel, introducing water into the gravity transmission unit and the generator set from the withdrawal inlet located at the upstream of a river through the withdrawal channel, and discharging water back to the river via the discharge channel after power generation.

Compared with traditional thermal power generations, the hydroelectric power generation device according to the present invention is characterized in that it does not require equipments of high temperature, high pressure and high speed, but utilizes solar energy and is more environmentally protective. Moreover, in comparison with conventional hydroelectric power generation facilities, the present invention needs not dams or reservoirs for water interceptions, featuring less operation space as well as better friendliness to surrounding environment and ecological systems.

### BRIEF DESCRIPTION OF THE DRAWINGS

FIG. 1 shows a unit diagram of the hydroelectric power generation device according to the present invention.

FIG. 2 shows a unit diagram of the control and load device according to the present invention.

FIG. 3 shows a diagram of the potential energy generation unit according to the present invention.

FIGS. 3A to 3F show operation diagrams of the potential energy generation unit and the steam boiler according to the present invention.

FIG. 4 shows a diagram of the gravity transmission unit according to the present invention.

FIG. 5 shows a unit diagram of the hydroelectric power generation device according to the present invention.

### DETAILED DESCRIPTION OF THE PREFERRED EMBODIMENTS

The embodiments of the present invention will now be set forth below in details, in conjunction with appended drawings and component symbols indicated therein, such that those skilled ones in the art can better appreciate the contents of the present invention for practice from reading the present disclosure.

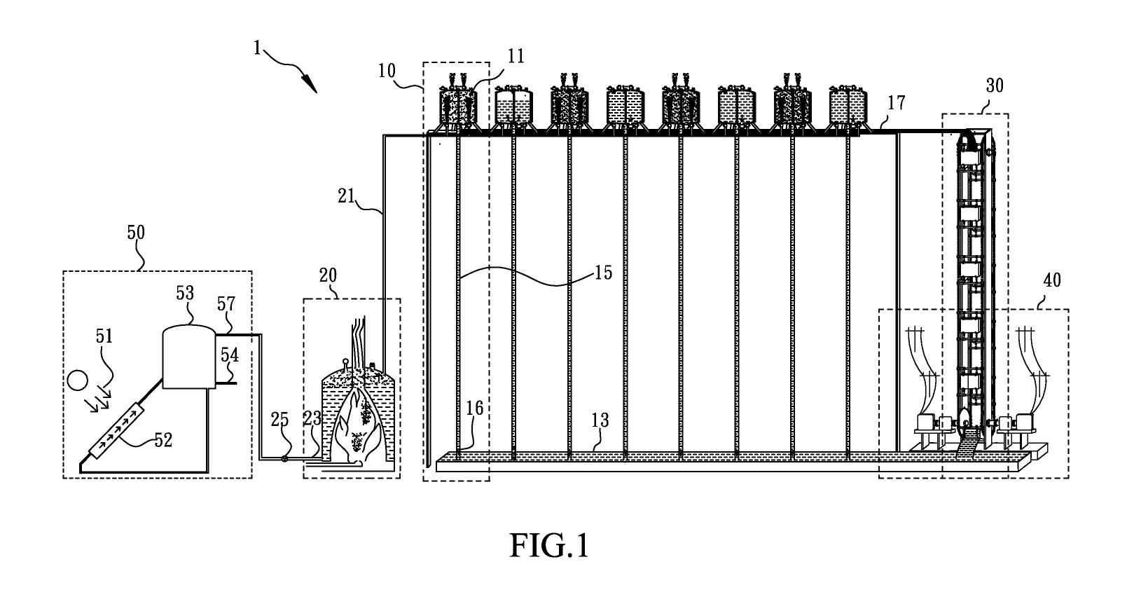

Refer first to FIG. 1, wherein a unit diagram of the hydroelectric power generation device according to the present invention is shown. In FIG. 1, it can be seen that the hydroelectric power generation device 1 according to the present invention comprises at least a potential energy generation unit 10, a steam boiler 20, a gravity transmission unit 30, a generator set 40 and a solar water heater 50. The potential energy generation unit 10 includes a control and load device 11, a withdrawal tank 13, a withdrawal pipe 15, a check valve 16 and a collection tank 17. The control and load device 11 is connected to the withdrawal tank 13 through the withdrawal pipe 15 for water withdrawals, and the collection tank 17 is connected to the control and load device 11 in order to receive water discharged from the control and load device 11. The steam boiler 20 is connected to the control and load device 11 by way of the upper pipeline 21 and to the hot water output pipe 57 of the heat storage bucket 53 in the solar water heater 50 through the lower pipeline 23, respectively. The steam boiler 20 withdraws hot water from the heat storage bucket 53 in the solar water heater 50 through the lower pipeline 23, generates steam, and then discharges the steam to the control and load device 11 via the upper pipeline 21. The gravity transmission unit 30 is connected to the collection tank 17, receiving water from the collection tank 17, thereby using the potential energy contained in the water to drive the generator set 40 to rotate for power generation.

Also, the solar water heater 50 includes solar radiation heat 51, a heat collection board 52, a heat storage bucket 53, a cool water input pipe 54 and a hot water output pipe 57. Herein the heat collection board 52 receives solar radiation heat 51 such that the water inside the cool water input pipe 54 is heated as flowing through the heat collection board 52, then transferred into the heat storage bucket 53 and further to the steam boiler 20 by way of the hot water output pipe 57.

Furthermore, a boiler water feed element 25 is installed between the solar water heater 50 and the steam boiler 20 for controlling the water fed to the steam boiler.

In case of multiple potential energy generation units 10, it is possible to connect respectively the withdrawal tank 13 and the collection tank 17 in each of the potential energy generation units 10 with each other as a single piece.

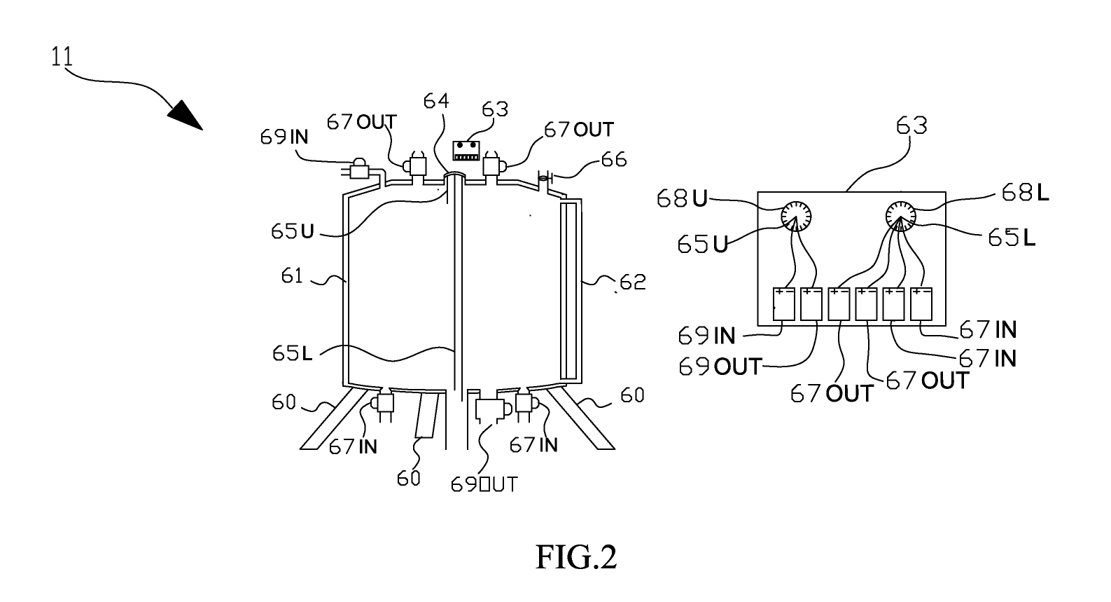

Refer next to FIG. 2, wherein a unit diagram of the control and load device 11 is shown, including a pedestal 60, a heat insulation outer frame 61, a water level gauge 62, a microcomputer controller 63, a multi-leveled control sense component 64, a plurality of electromagnetic valve sense switches and a manual switch 66. The multi-leveled control sense component 64 includes an upper water level limit sensor 65U and a lower water level limit sensor 65L; herein the upper water level limit sensor 65U and the lower water level limit sensor 65L are installed inside the heat insulation outer frame 61, while the microcomputer controller 63 and the plurality of electromagnetic valve sense switches are installed outside the heat insulation outer frame 61.

Besides, the timer 68L contained in the microcomputer controller 63 is internally connected to the lower water level limit sensor 65L of the multi-leveled control sense component 64 in order to detect the lower limit of the water level and to control the opening and closing states of at least an electromagnetic valve steam inlet 67IN and an electromagnetic valve steam outlet 67OUT. On the other hand, the timer 68U contained in the microcomputer controller 63 is internally connected to the upper water level limit sensor 65U of the multi-leveled control sense component 64 in order to detect the upper limit of the water level and to control the opening and closing states of an electromagnetic valve air inlet 69IN and an electromagnetic valve water outlet 69OUT.

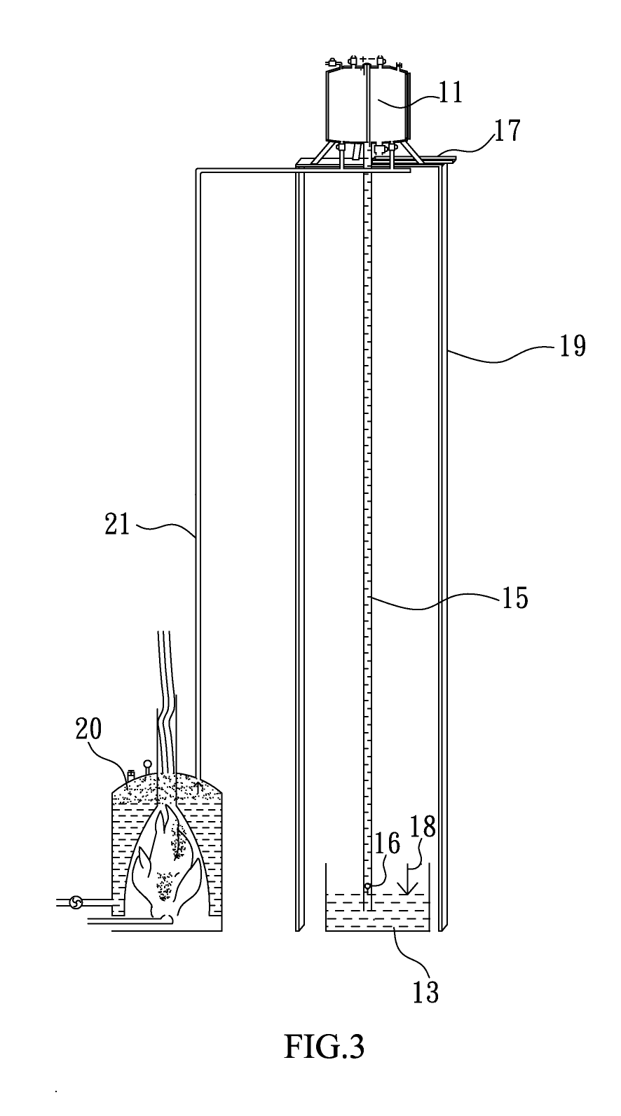

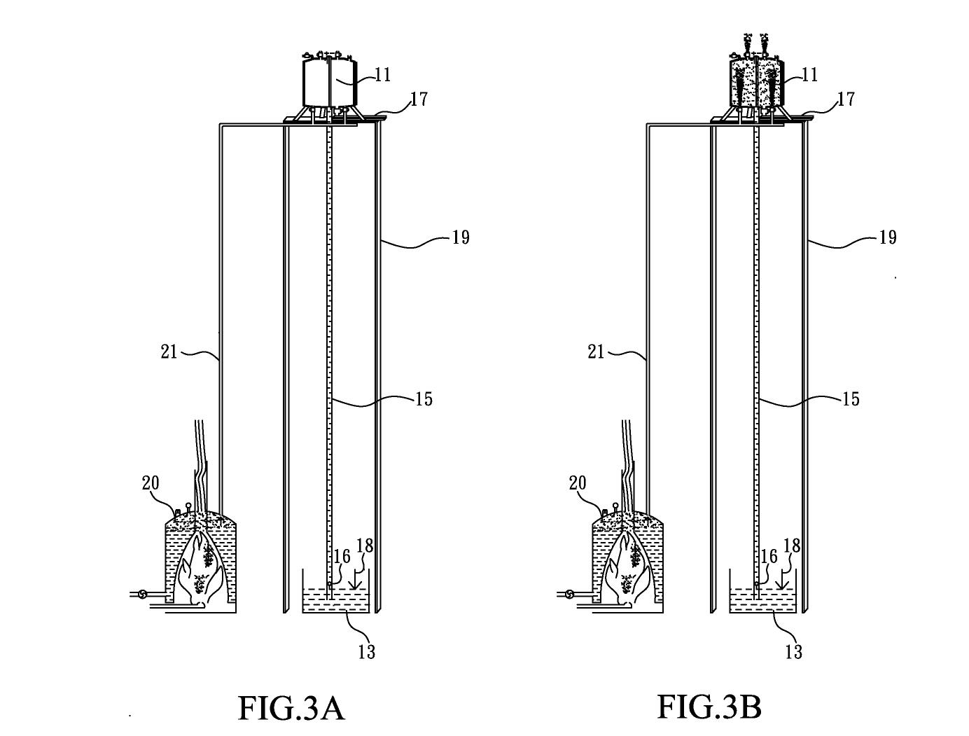

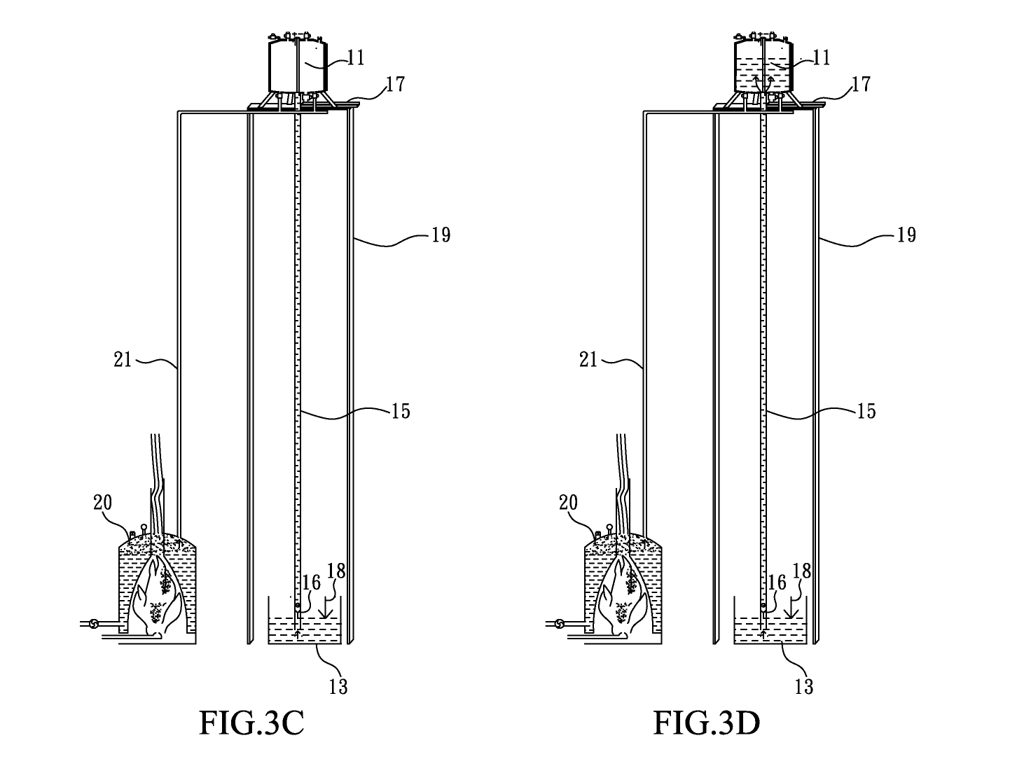

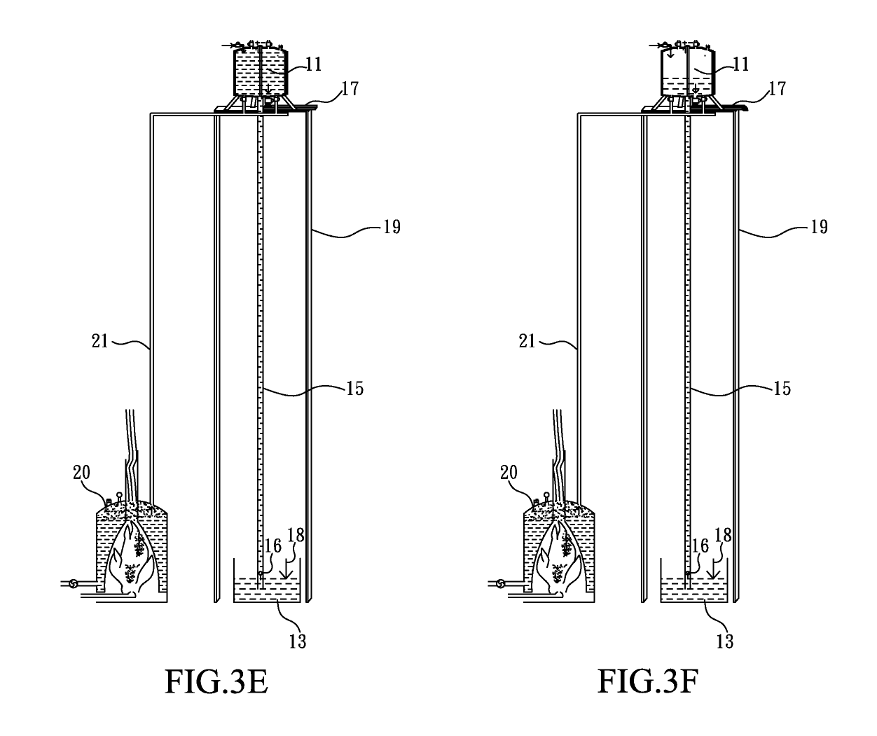

Referring to FIG. 3, the potential energy generation unit 10 further includes a supporter 19 for positioning the control and load device 11, the withdrawal pipe 15 as well as the withdrawal tank 13 in fixation. By enabling the manual switch 66, water can flow into the control and load device 11 such that the water level reaches the lower water level limit sensor 65L.

Refer next to FIGS. 3A to 3F, wherein operation diagrams of the potential energy generation unit 10 and the steam boiler 20 according to the present invention are respectively shown. In FIG. 3A, when the water level reaches the lower water level limit sensor 65L, the microcomputer controller 63 is enabled. In FIG. 3B, when the water level reaches the lower water level limit sensor 65L, the electromagnetic valve steam inlet 67IN and the electromagnetic valve steam outlet 67OUT are opened based on the detection by the microcomputer controller 63, so the steam generated by the steam boiler 20 can be injected to the control and load device 11, thus emitting the air and steam through the electromagnetic valve steam outlet 67OUT. In FIG. 3C, the electromagnetic valve steam inlet 67IN and the electromagnetic valve steam outlet 67OUT are simultaneously closed in accordance with the detection from the time programmed in the timer 68L of the microcomputer controller 63, so the steam starts to condense thereby forming a pressure difference from the atmospheric pressure. In FIG. 3D, by means of such a pressure difference, the check valve 16 is opened and water is automatically sucked in from the withdrawal pipe 15, causing elevation of water level. In FIG. 3E, when the water level ascends to reach the upper water level limit sensor 65U, the electromagnetic valve air inlet 69IN and the electromagnetic valve water outlet 69OUT are opened at the same time according to the detection of the microcomputer controller 63. Next, in FIG. 3F, the electromagnetic valve air inlet 69IN and the electromagnetic valve water outlet 69OUT are simultaneously opened, so the water in the control and load device 11 is released to the collection tank 17, and when the water level falls down to reach the lower water level limit sensor 65L, the electromagnetic valve air inlet 69IN and the electromagnetic valve water outlet 69OUT are simultaneously closed in accordance with the detection from the time programmed in the timer 68U of the microcomputer controller 63, thus repeating the operations started from FIG. 3A. The potential energy generation unit 10 of the present invention operates continuously and repeatedly in accordance with the fashion shown in FIGS. 3A to 3F.

Moreover, the time programmed in the timer 68L of the microcomputer controller 63 can be set based on the duration required for the water level gauge 62 to ascend to the top end, and the time programmed in the timer 68U of the microcomputer controller 63 can be otherwise set based on the duration required for the water level gauge to descend to the bottom end.

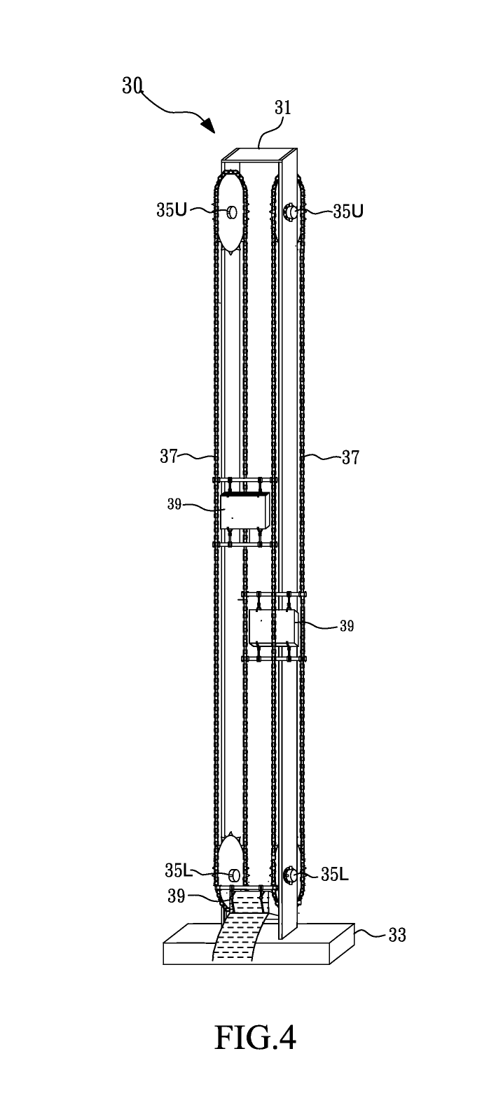

Now refer to FIG. 4, wherein a diagram of the gravity transmission unit according to the present invention is shown. As shown in FIG. 4, the gravity transmission unit 30 includes a Π-shaped top board 31, a bottom board 33, two upper bearing transmission devices 35U, two lower bearing transmission devices 35L, two chain sprockets 37 and a plurality of load devices 39, in which the Π-shaped top board 31 is fixed to the bottom board 33 and connected to the collection tank 17, while the bottom board 33 is connected to the withdrawal tank 13. The two upper bearing transmission devices 35U and the two lower bearing transmission devices 35L are respectively installed in pair on an upper part and a lower part of the Π-shaped top board 31, the two lower bearing transmission devices 35L are further respectively connected to the generator set 40, the two chain sprockets 37 are installed in pair on the upper bearing transmission devices 35U and the lower bearing transmission devices 35L, and the plurality of load devices 39 are connected between the two chain sprockets 37.

When the water in the collection tank 17 flows into the load devices 39, the load devices 39 start to descend and the gravity thus created drives the upper bearing transmission devices 35U and the lower bearing transmission devices 35L to rotate, thereby causing the generator set 40 connected to the lower bearing transmission devices 35L to operate for power generation; whereas, upon descending to reach the bottom board 33, the load devices 33 discharge water which flows into the withdrawal tank 13, and then ascend, thus operating repeatedly.

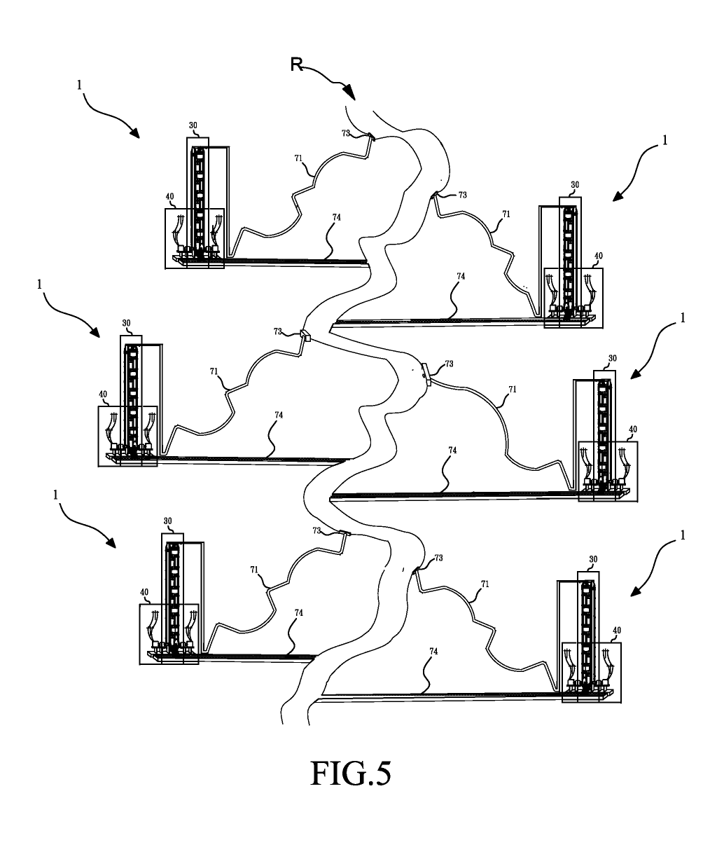

Refer finally to FIG. 5, wherein a plurality of gravity transmission units and generator sets 40 according to the present invention can be installed at the upstream and downstream locations of a river R in a serial connection for power generation; it is possible to construct a withdrawal channel 71 and introduce water in the river R through a withdrawal inlet 73 into the load devices 39 of the gravity transmission device 30 for power generation. The introduced water can flow back to the river R via the discharge channel 74 after power generation operations.

Compared with traditional thermal power generations, the hydroelectric power generation device according to the present invention does not require equipments of high temperature, high pressure and high speed, but utilizes solar energy and is more environmentally protective.

Moreover, in comparison with conventional hydroelectric power generation facilities, the hydroelectric power generation device according to the present invention needs not dams or reservoirs for water interceptions, featuring less operation space as well as better friendliness to surrounding environment and ecological systems.

The descriptions set forth as above are simply to illustrate the preferred embodiments of the present invention, rather than being intended to limit the scope thereof in any forms. Therefore, all possible modifications or alternations made to the present invention in accordance with the same inventive spirit should be considered to be within the scope of the present invention claimed for legal protections.

What is claimed is:

1. A hydroelectric power generation device, comprising:
at least a potential energy generation unit, each of the potential energy generation units including a control and load device, a withdrawal tank, a withdrawal pipe and a collection tank, in which the control and load device is connected to the withdrawal tank through the withdrawal pipe such that the water in the withdrawal tank can be withdrawn to the control and load device through the withdrawal pipe, and the collection tank is connected to the control and load device so as to receive the water discharged from the control and load device;
a steam boiler, including an upper pipeline and a lower pipeline and connected to each of the control and load devices via the upper pipeline, generating steam and discharging the steam to the control and load device through the upper pipeline;
a solar water heater, including a heat storage bucket and a hot water output pipe and connecting the heat storage bucket to the lower pipeline of the steam boiler through the hot water output pipe to provide hot water to the steam boiler;
a gravity transmission unit, connected to the collection tank of the control and load device and receiving water from the collection tank to further create gravity kinetic energy; and
a generator set, connected to the gravity transmission unit and driven to rotate with the gravity kinetic energy created by the gravity transmission unit thereby further generating electrical power.

2. The hydroelectric power generation device according to claim 1, wherein in case that the number of the at least a potential energy generation units is more than two, the withdrawal tank and the collection tank in each of potential energy generation units is respectively connected.

3. The hydroelectric power generation device according to claim 1, wherein the control and load device includes a pedestal, a heat insulation outer frame, a water level gauge, a microcomputer controller, a multi-leveled control sense component, an electromagnetic valve steam inlet, an electromagnetic valve steam outlet, an electromagnetic valve air inlet and an electromagnetic valve water outlet; in which the multi-leveled control sense component includes an upper water level limit sensor and a lower water level limit sensor which are installed inside the heat insulation outer frame; in which the microcomputer controller is connected to the electromagnetic valve steam inlet, the electromagnetic valve steam outlet, the electromagnetic valve air inlet and the electromagnetic valve water outlet and installed outside the heat insulation outer frame, and also the microcomputer controller is connected to the upper water level limit sensor and the lower water level limit sensor in the multi-leveled control sense component thereby detecting the upper limit and the lower limit of the water level; in which the heat insulation outer frame is connected to the withdrawal pipe, the withdrawal pipe is connected to the withdrawal tank, the electromagnetic valve water outlet is connected to the collection tank, and the microcomputer controls the opening and closing states of the electromagnetic valve steam inlet, the electromagnetic valve steam outlet, the electromagnetic valve air inlet and the electromagnetic valve water outlet so as to enable or disable water withdrawals from the withdrawal tank or otherwise enable or disable water discharges from the control and load device.

4. The hydroelectric power generation device according to claim 3, wherein the control and load device enables the electromagnetic valve steam inlet, the electromagnetic valve steam outlet, the electromagnetic valve air inlet and the electromagnetic valve water outlet to withdraw water from the withdrawal tank through the withdrawal pipe, and when the microcomputer controller detects the water level reaches the lower water level limit, at least a steam inlet is opened to inject the steam such that the air in the control and load device is discharged from the at least a steam outlet, and then the at least a steam inlet and the at least a steam outlet are closed such that the inside of the control and load device demonstrates a low-pressure condition thereby automatically sucking in water through the withdrawal pipe, until the microcomputer controller detects the water level rises up to reach the upper water level limit sensor, then the at least an air inlet and a water outlet are opened to discharge the water to the collection tank, thus operating repeatedly.

5. The hydroelectric power generation device according to claim 1, wherein the potential energy generation unit further includes a supporter thereby positioning the control and load device, the withdrawal pipe and the withdrawal tank in fixation.

6. The hydroelectric power generation device according to claim 1, wherein the gravity transmission unit includes a Π-shaped top board, a bottom board, two upper bearing transmission devices, two lower bearing transmission devices, two chain sprockets and a plurality of load devices, in which the Π-shaped top board is fixed to the bottom board and connected to the collection tank, the bottom board is connected to the withdrawal tank, the two upper bearing transmission devices and the two lower bearing transmission devices are respectively installed in pair on an upper part and a lower part of the Π-shaped top board, the two lower bearing transmission devices are further respectively connected to the generator set, the two chain sprockets are installed in pair on the upper bearing transmission devices and the lower bearing transmission devices, and the plurality of load devices are connected between the two chain sprockets.

7. The hydroelectric power generation device according to claim 6, wherein the load devices start to descend upon being filled with water from the collection tank, and the gravity thus introduced drives the two upper bearing transmission devices and the two lower bearing transmission devices to rotate thereby driving the generator set connected to the lower bearing transmission devices to generate electrical power; when the load devices descend to reach the bottom board, the water is drained from the load devices and flows to the withdrawal tank, then the load devices ascend, thus operating repeatedly.

8. The hydroelectric power generation device according to claim 6, wherein the solar water heater includes a solar radiation heat, a heat collection board, a heat storage bucket, a cool water input pipe and a hot water output pipe, in which the heat collection board receives solar radiation heat such that the water inside the cool water input pipe is heated as flowing through the heat collection board, then transferred into the heat storage bucket and further to the steam boiler by way of the hot water output pipe.

9. The hydroelectric power generation device according to claim 1, further comprising, by means of a withdrawal inlet, a withdrawal channel and a discharge channel, introducing water into the gravity transmission unit and the generator set from the withdrawal inlet located at the upstream of a river through the withdrawal channel, and discharging water back to the river via the discharge channel after power generation.
